(19) United States
(12) Patent Application Publication
(10) Pub. No.: US 2026/0187991 A1
(43) Pub. Date: Jul. 2, 2026

(54) KNOWLEDGE-AUGMENTED FEATURE ADAPTER FOR VISION-LANGUAGE MODEL NEURAL NETWORKS

(71) Applicant: Google LLC, Mountain View, CA (US)

(72) Inventors: Arjun Reddy Akula, Sunnyvale, CA (US); Pradyumna Narayana, Bothell, WA (US); Garima Pruthi, San Jose, CA (US); Sugato Basu, Redwood City, CA (US); Varun Jampani, Rockland, MA (US)

(21) Appl. No.: 18/858,378

(22) PCT Filed: May 26, 2023
(86) PCT No.: PCT/US2023/023711

§ 371 Date: Oct. 21, 2024

(51) Int. Cl. G06V 10/82; B25J 9/16

(52) U.S. Cl. CPC G06V 10/82; B25J 9/161

(57) ABSTRACT

Methods, systems, and apparatus, including computer programs encoded on computer storage media, for performing a multi-modal machine learning task on a network input that includes text and an image to generate a network output. One of the systems includes a vision-language model (VLM) neural network. The VLM neural network includes a VLM backbone neural network and an attention-based feature adapter. The VLM neural network has access to an external dataset that stores multiple text items.

### BACKGROUND

This specification relates to machine learning.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a knowledge-augmented neural network system, e.g., a neural network system that is augmented with an external database, implemented as computer programs on one or more computers in one or more locations that performs one or more multi-modal machine learning tasks on a network input. A multi-modal machine learning task is a task that involves the neural network processing an input that includes data from two or more modalities to generate the output for the task. For example, the input can include both visual data and textual data.

According to an aspect, there is provided a system for performing a multi-modal machine learning task on a network input that includes text and an image to generate a network output, the system including one or more computers and one or more storage devices storing instructions that, when executed by the one or more computers, cause the one or more computers to implement: a vision-language model (VLM) neural network configured to perform the multi-modal machine learning task, the VLM neural network including: a backbone image encoder neural network configured to process the image included in the network input to generate an image embedding; a backbone text encoder neural network configured to process the text included in the network input to generate one or more text embeddings; and an attention-based feature adapter, the attention-based feature adapter configured to: combine the image embedding, the one or more text embeddings, and respective positional embeddings to generate a combined embedding; generate an attended image embedding at least in part by applying an attention mechanism to the combined embedding; and generate the network output based on the attended image embedding.

Other embodiments of this aspect include corresponding methods including the operations performed by the system, computer systems, and computer programs recorded on one or more computer storage devices, each configured to perform the actions of the above system.

The foregoing and other embodiments can each optionally include one or more of the following features, alone or in combination. In particular, one embodiment includes all the following features in combination.

The backbone image encoder neural network and the backbone text encoder neural network can be jointly pre-trained on a text-image alignment task, the backbone image encoder neural network and the backbone text encoder neural network can each have a respective pre-trained parameter values determined from the pre-training.

Generating the attended combined image embedding can include generating an attended combined embedding at least in part by applying the attention mechanism by using queries, keys, and values derived from the combined embedding; and generating, in accordance with an order in which the image embedding and the one or more text embeddings are combined, the attended image embedding from the attended combined embedding.

Generating the network output based on the attended image embedding can include generating a combination of the attended image embedding with the image embedding; and generating the network output from the combination.

The attention mechanism can include a multi-head attention mechanism.

The multi-modal machine learning task may comprise an agent control task, and the network output may specify one or more actions to be performed by the agent.

The agent can include a robot.

The multi-modal machine learning task can include one of an image captioning task or a visual question answering task.

According to another aspect, there is provided a computer-implemented method including maintaining a database that stores keywords and, for each keyword, supplemental information corresponding to the keyword; receiving an image; processing a region proposal network input that includes the image using a region proposal neural network to identify one or more regions in the image that are determined to likely contain content related to one or more of the keywords; processing one or more image encoder network inputs that include one or more images patches corresponding to the one or more regions using an image encoder neural network to generate an image embedding for each of the one or more images patches; for each of the keywords, processing one or more text encoder network inputs that each include at least the keyword using a text encoder neural network to generate one or more text embeddings for the keyword; determining similarity measures between (i) the image embedding for each of the one or more images patches and (ii) the one or more text embeddings for each of the keywords; and selecting, based at least on the similarity measures and from the database, (i) a keyword that is most relevant to the content depicted in the image and (ii) supplemental information corresponding to the selected keyword.

Other embodiments of this aspect include corresponding systems and computer programs recorded on one or more computer storage devices, each configured to perform the actions of the above method aspect.

The foregoing and other embodiments can each optionally include one or more of the following features, alone or in combination. In particular, one embodiment includes all the following features in combination.

The method can include processing the image using optical character recognition (OCR) to obtain OCR text corresponding to text depicted in the image.

Selecting the selected keyword that is most relevant to the content depicted in the image further can include determining a match result of each of the keywords with respect to the OCR text; and selecting the keyword based on both the similarity measures and the match results.

Selecting the keyword based on both the similarity measures and the match results can include selecting the keyword in accordance with a set of ensemble rules that are configured to assign different weights to the match results and the similarity measures.

The region proposal neural network can include a multi-modal Transformer neural network that has been pre-trained on an object detection task.

The region proposal network input can include region proposal prompt text.

Generating the image embedding for each of the one or more regions can include processing an image encoder network input that includes the image using the image encoder neural network to generate an image embedding for the image.

The text encoder network input can include (i) the keyword and, (ii) the supplemental information corresponding to the keyword, (iii) text encoder prompt text, or both (ii) and (iii).

The method can include determining, based on the selected keyword and the supplemental information corresponding to the selected keyword, whether to provide the image for presentation on a client device.

Providing the image for presentation on the client device can include generating a digital component that includes the image; and providing the digital component that includes image for presentation on the client device.

The method can include determining, based on the selected keyword and the supplemental information corresponding to the selected keyword, whether to modify the image.

The method can include generating a digital component that include the selected keyword, the supplemental information corresponding to the selected keyword, or both.

Particular embodiments of the subject matter described in this specification can be implemented so as to realize one or more of the following advantages. A knowledge-augmented neural network system, as described in this specification, is a machine learning system that can achieve high levels of performance on a range of multi-modal machine learning tasks that involve processing both visual and textual data. The described neural network system leverages relevant information retrieved from an external database and the feature computation power of an attention-based feature adapter to enhance the accuracy of a pre-trained vision-language model neural network on multi-modal machine learning tasks. From another point of view, this increase in performance makes possible a reduction in training time and/or computing resource consumption compared to other machine learning systems. Moreover, some implementations of the neural network system can use the retrieved information to additionally take a number of actions that fit the customized needs of various users of the system. For example, the capability to use custom image and/or text to identify from an external knowledge base the best matching (or most relevant) keywords and associated supplemental information that respond to or expand upon the custom image and/or text can significantly improve user engagement with the system.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 shows example operations performed by a neural network system to select text items from a database.

FIG. 3 shows text items stored in an example database.

FIG. 4 is a flow diagram of an example process for performing a multi-modal machine learning task on a network input to generate a network output.

FIG. 5 shows example pseudo code to implement an attention-based feature adapter.

FIG. 6 is a flow diagram of an example process for selecting a keyword and supplemental information corresponding to the keyword from a database.

FIG. 7 is a block diagram of an example computer system that can be used to perform operations described herein.

Like reference numbers and designations in the various drawings indicate like elements.

### DETAILED DESCRIPTION

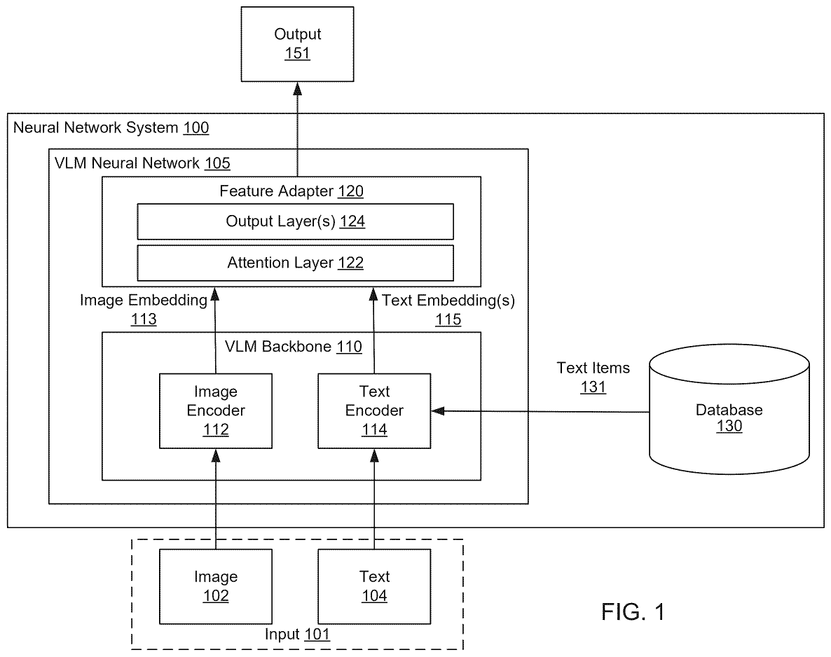

FIG. 1 shows an example neural network system 100. The neural network system 100 is an example of a system implemented as computer programs on one or more computers in one or more locations, in which the systems, components, and techniques described below can be implemented.

The neural network system 100 can receive an input 101 and perform a multi-modal machine learning task on the input 101 to generate an output 151. A multi-modal machine learning task is a task that involves the neural network processing an input that includes data from two or more modalities in order to generate the output for the task. Thus, as shown in FIG. 1, the system receives an input 101 that includes both an image 102 (that is, visual data) and text 104 (that is, textual data).

The neural network system 100 can receive the input 101 in any of a variety of ways. For example, the system 100 can receive the image 102, the text 102, or both as an upload from a remote user of the system over a data communication network, e.g., using an application programming interface (API) made available by the system 100. As another example, the system 100 can receive an input from a user specifying which data that is already maintained by the system 100 should be used as the image 102, the text 104, or both. In fact, the system 100 need not obtain the image 102 and the text 104 from the same user or from the same source. For example, the system 100 can receive a user request that includes the text 104 as part of the request while identifying a storage location from which the system can retrieve the image 102 (or vice versa).

As used herein, the term “image” is used in the broadest sense, referring to any image data or digital data that defines an image. Images may, for example, be two dimensional, three dimensional, or even in the form of a video. Images may be captured by a scanner, a camera, a specially-adapted sensor array (such as a CCD array or a CMOS array), a microscope, a smartphone camera, a video camera, an x-ray machine, a sonar, an ultrasound machine, a microphone (or other instruments for converting sound waves into electrical energy variations), etc. The term “text” is also used in the broadest sense, referring to any natural language text, or even source code snippet.

In some examples, the multi-modal machine learning task is a visual question answering task, where the text 104 includes (i) a question that is posed about the image 102 and (ii) a set of possible answers to the question. To perform the visual question answering task, the neural network system 100 is configured to process the input 101 to select the most appropriate answer to the question from the set of possible answers. As a particular example, the visual question answering task can be an image understanding task and the possible answers to the questions each include a respective class of text items. In one example, the class of items can be a brand, a product, or a service of an organization.

In some other examples, the multi-modal machine learning task is an image captioning task, where the text 104 includes a set of possible text captions for the image 102. To perform the image captioning task, the neural network system 100 is configured to process the input 101 to select the most accurate text caption for the image 102 from the set of possible text captions.

In any of these examples, the image 102, the text 104, or both may be received as part of a dialog, e.g., in one or more dialog turns, between a user and a conversation agent implementing or having access to the neural network system 100.

In yet other examples, the multi-modal machine learning task is an agent control task. The agent can be, e.g., a real-world or simulated robot, a control system for an industrial facility, or a control system that controls a different kind of agent. The tasks can for example include causing the agent to navigate to different locations in an environment, causing the agent to locate different objects, causing the agent to pick up different objects or to move different objects to one or more specified locations, and so on. The agent, e.g., a robot, typically moves (e.g. navigates and/or changes its configuration) within the environment.

In these examples, the neural network system 100 can be configured to receive an input that includes an observation that characterizes a state of the environment and an input text sequence that defines a set of possible actions that can be performed by the agent (e.g., “turn left,” “speed up,” “activate lights,” and so on), and to process the input to select, from the set of possible actions, a selected action to be performed by the agent in response to the observation. The observations can include images, such as ones captured by a camera and/or Lidar sensor, that characterize the environment.

In particular, the neural network system 100 is a knowledge-augmented neural network system. That is, the neural network system 100 includes a visual-language model (VLM) neural network 105 configured to receive an input 101 and generate an output 151, and an external database 130, e.g., a database that is external to the VLM neural network 105, that stores multiple text items 131 that can assist in the VLM neural network 105 in performing the task on the input 101.

The database 130 can store any information that is relevant to one or more aspects of the multi-modal machine learning task in the form of text items. Accordingly, instead of processing just the input 101 to generate the output 151, the VLM neural network 105 additionally uses one or more text items 131 selected from the database 130 to assist in performing the multi-modal machine learning task on the input 101 to generate the output 151.

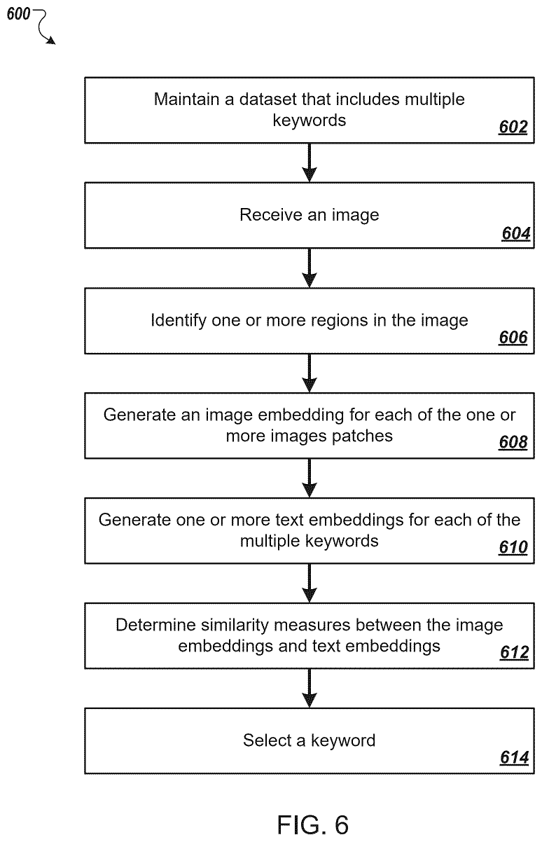

In particular, the VLM neural network 105 is configured to generate the output 151 by processing the input 101 to select one or more text items 131 from the database 130, and processing the one or more selected text items 131 together with the input 101 to generate the output 151. The system selects these text items 131 from the database 130 based on their similarity measures to the image 102, the text 104 or both included in the input 101, as will be described further below with reference to FIG. 6.

The VLM neural network 105 includes a VLM backbone neural network 110, which in turn includes an image encoder neural network 112 and a text encoder neural network 114, and an attention-based feature adapter 120. Generally, the VLM backbone neural network 110 can have any appropriate architecture that allows the VLM neural network 105 to perform the multi-modal machine learning task. One example of the appropriate architecture of the VLM backbone neural network 110 is described in Jia, Chao, et al. “Scaling up visual and vision-language representation learning with noisy text supervision.” International Conference on Machine Learning. PMLR, 2021, Radford, Alec, et al. “Learning transferable visual models from natural language supervision.” International conference on machine learning. PMLR, 2021. Another example of the appropriate architecture of the VLM backbone neural network 110 is described in Zhai, Xiaohua, et al. “Lit: Zero-shot transfer with locked-image text tuning.” Proceedings of the IEEE/CVF Conference on Computer Vision and Pattern Recognition. 2022. The entire contents of the foregoing publications are hereby incorporated by reference herein in their entirety.

In some implementations, the VLM backbone neural network 110 is a neural network have has been pre-trained, e.g., either as a standalone neural network or as a part of a larger neural network, on a large image-and-text paired data set through representation learning, e.g., to minimize a contrastive learning loss or other representation learning loss, on a text-image alignment task. For example, the text-image alignment task can be any one of the alignment tasks mentioned in the above references. In these implementations, the image encoder neural network 112 and the text encoder neural network 114 are jointly pre-trained, and the image encoder neural network 112 and the text encoder neural network 114 each have a respective plurality of parameters having pre-trained values determined as a result of the joint pre-training.

The image encoder neural network 112 is configured to process the image 102 in accordance with the parameters of the image encoder neural network 112 to generate an image embedding 113. The text encoder neural network 114 is configured to process the text 104 in accordance with the parameters of the text encoder neural network 114 to generate one or more text embeddings 115. The neural network system 100 then uses these embeddings to select one or more text items 131 from the database 130. For each selected text item 131, the text encoder neural network 114 is also configured to process the selected text item 131 in accordance with the parameters of the text encoder neural network 114 to generate a text embedding 115 for the selected text item 131.

In implementations where the image encoder neural network 112 and the text encoder neural network 114 have been jointly pre-trained on a text-image alignment task, the image encoder neural network 112 and the text encoder neural network 114 can generate the image embedding 113 and the text embeddings 115 in the same embedding space, e.g., a co-embedding space that includes both image embeddings and text embeddings.

An “embedding” as used in this specification is a vector of numeric values, e.g., floating point values or other values, having a pre-determined dimensionality. The space of possible vectors having the pre-determined dimensionality is referred to as the “embedding space.”

The attention-based feature adapter 120 receives the image embedding 113 and the text embeddings 115 from the VLM backbone neural network 110 and then processes these embeddings to generate the output 151.

To generate the output 151 from the received embeddings, the attention-based feature adapter 120 includes an attention layer 122 and one or more output layers 124. An attention layer is a neural network layer that includes an attention mechanism that operates over an attention layer input (or an input derived from the attention layer input) to generate an attention layer output. There are many different possible attention mechanisms. Some examples of attention layers including attention mechanisms, e.g., query-key-value (QKV) attention mechanisms, are described in Vaswani, et al, “Attention Is All You Need,” arXiv:1706.03762, Raffel, et al, “Exploring the Limits of Transfer Learning with a Unified Text-to-Text Transformer,” arXiv:1910.10683, Devlin et al, “BERT: Pre-training of Deep Bidirectional Transformers for Language Understanding,” arXiv:1810.04805, Kitaev, et al, “Reformer: The Efficient Transformer,” arXiv:2001.04451, and “Language models are few-shot learners.” arXiv preprint arXiv:2005.14165.

Generally, an attention mechanism maps a query and a set of key-value pairs to an output, where the query, keys, and values are all vectors. The output is computed as a weighted sum of the values, where the weight assigned to each value is computed by a compatibility function, e.g. a dot product or scaled dot product, of the query with the corresponding key.

For example, a self-attention mechanism is configured to relate different positions in the same input sequence to determine a transformed version of the sequence as an output sequence. For example the attention layer input may comprise a vector for each element of the input sequence. These vectors provide an input to the self-attention mechanism and are used by the self-attention mechanism to determine a new representation of the same sequence for the attention layer output, which similarly comprises a vector for each element of the input sequence. An output of the self-attention mechanism may be used as the attention layer output, or it may be processed by one or more of feed-forward layers, skip connections, or normalization operations to provide the attention layer output.

The attention mechanism may implement multi-head attention, that is, it may apply multiple different attention mechanisms in parallel. The outputs of these may then be combined, e.g. concatenated, with a learned linear transformation applied to reduce to the original dimensionality if necessary.

The attention layer 122 is lightweight, namely it has a limited number of parameters. When fine-tuning is involved to adapt the VLM neural network 105 having the pre-trained VLM backbone neural network 110 to the multi-modal machine learning task, this can allow the training of the attention-based feature adapter 120 to converge faster and reduce the amount of computational resources consumed by the fine-tuning process, e.g., by holding the parameters of the pre-trained VLM backbone neural network 110 fixed. This specific choice of the feature adapter as an attention-based feature adapter, e.g., a feature adapter that includes an attention layer, better leverages the pre-trained VLM backbone neural network and substantially improves the overall performance of the VLM neural network on the task.

The one or more output layers 124 then processes the attention layer output to generate the output 151. In some implementations, the one or more output layers 124 include a residual connection layer followed by a layer normalization layer followed by a final output layer. The residual connection layer combines the attention layer output with the attention layer input to generate a residual connection layer output. The layer normalization layer applies layer normalization to the residual connection layer output to generate a normalized residual connection layer output, which is then provided as input to the final layer.

The final layer can have any appropriate configuration that allows the VLM neural network 105 to generate the output 151 as required by the multi-modal machine learning task. For example, when the task involves the VLM neural network 105 to make a selection from among a set of multiple candidate outputs defined by the text 104 included in the input 101, the final layer can be a softmax layer that outputs a respective numerical probability value for each candidate output. To generate the output 151 from the probability output of the final layer, the neural network system 100 could select a candidate output, e.g., by sampling a candidate output in accordance with the probability values for the candidate outputs, or by selecting the candidate output with the highest probability value.

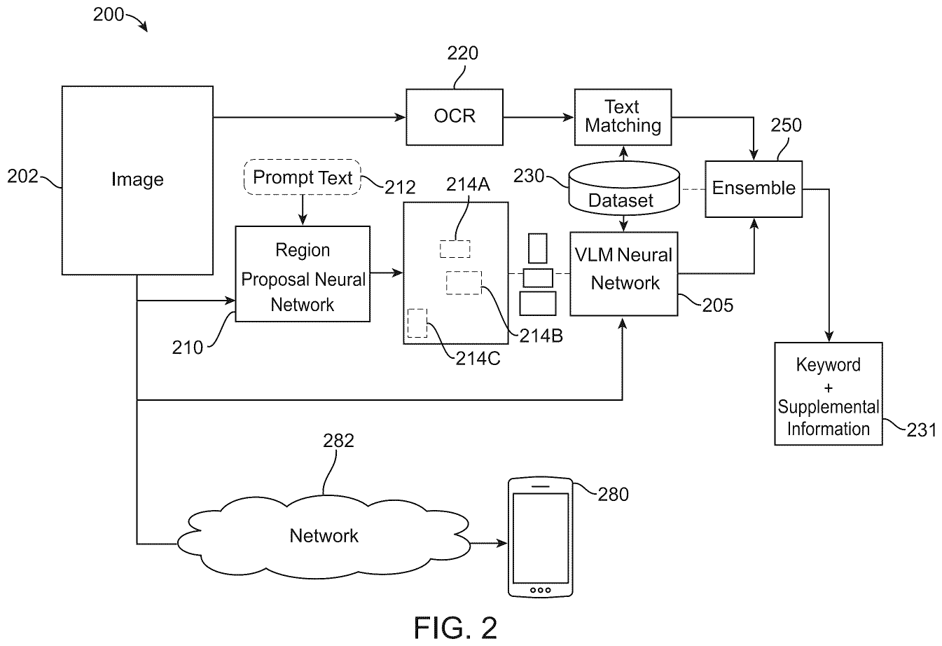

FIG. 2 shows example operations performed by a neural network system 200 to select text items from a database 230 that stores multiple text items. The neural network system 200 is an example of a system implemented as computer programs on one or more computers in one or more locations that receives an input that includes an image 202 and uses the image 202 to select one or more text items from the dataset 230. In the example of FIG. 2, the multiple text items represent multiple keywords and associated supplemental information 231.

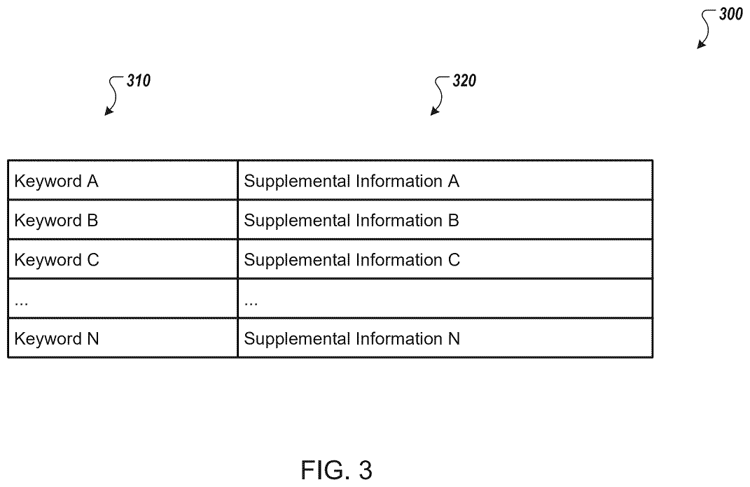

FIG. 3 shows text items stored in an example database. In the example of FIG. 3, the database is structured as a table 300. Other database structures are possible. The table 300 includes columns 310 and 320. Column 310 corresponds to keywords, where each row in column 310 corresponds to a particular keyword, e.g., keyword A, keyword B, keyword C, and so on. Column 320 corresponds to supplemental information associated with the keywords, where each row in column 320 corresponds to the supplemental information associated with a particular keyword, e.g., supplemental information associated with keyword A, supplemental information associated with keyword B, supplemental information associated with keyword C, and so on. The table 300 thus stores a mapping from each of the N keywords to the corresponding supplemental information that is associated with the keyword.

A keyword can be a unigram, e.g. consisting of a single word, or a multi-gram, e.g. consisting of multiple words. In a broader sense, a keyword can also include any string that consists of a sequence of characters, which may or may not have literal or practical meaning. For example, each keyword may identify a brand, a product, or a service that is offered by an entity. As another example, each keyword may identify a topic, e.g., a news topic or a subject of communication thread. As yet another example, each keyword may identify a geographic region, e.g., a city or a country.

For each keyword, the supplemental information can include any information in addition to, or associated with, the keyword. For example, the supplemental information can include any information that is relevant to the keyword, but is nevertheless not readily apparent from the keyword itself, among other information. In the example where each keyword identifies a brand, a product, or a service, the supplemental information may include additional information regarding the brand, e.g., a more detailed description of the brand, product, or service. In the example where each keyword identifies a topic, the supplemental information may include additional information that expands the keyword to other related topics, e.g., that a user may find of interest in view of the topic identified by the keyword. In the example where each keyword identifies a geographic region, the supplemental information may include additional information that represents characteristics of the geographic region.

In some cases, the neural network system 200 can generate the list of keywords and the associated supplemental information, e.g., by crawling the websites Internet for information related to various keywords. In other cases, the neural network system 200 can receive the list of keywords and the associated supplemental information from another entity, e.g., the entity that offers the brand, the product, or the service.

Referring back to FIG. 2, the neural network system 200 includes a visual-language model (VLM) neural network 205. As described above with reference to FIG. 1, the VLM neural network 205 includes an image encoder neural network and a text encoder neural network.

The text encoder neural network is configured to process, for each of the multiple keywords from the dataset 230, one or more text encoder network inputs that each include at least the keyword in accordance with the parameters of the text encoder neural network to generate one or more text embeddings for the keyword. In some implementations, one or more text encoder network inputs each include (i) the keyword and, (ii) the supplemental information corresponding to the keyword, (iii) prompt text (referred to below as “text encoder prompt text”), or both (ii) and (iii). When included, the prompt text in the one or more text encoder network inputs for the same keyword can be different from each other. For example, for a given keyword, the neural network system 200 can select, from a set of partial text sequences, a different partial text sequence for inclusion in each text encoder network input.

In some implementations, the neural network system 200 can store the generated text embeddings in a data repository such that the same text embeddings can be reused later for each new image 202 received by the system. The neural network system 200 can update these text embeddings as new keywords are being added to the dataset 230 (and, analogously, as existing keywords are being deleted from the dataset 230). Reusing the already generated text embeddings can reduce the burden on the computing resources as well as shorten the processing time each time the system is required to select one or more keywords and associated supplemental information from a received image.

The image encoder neural network is configured to process the image 202 in accordance with the parameters of the image encoder neural network to generate an image embedding for the image 202.

In addition, in some implementations, the image encoder neural network is configured to process one or more images patches in accordance with the parameters of the image encoder neural network to generate an image embedding for each of the one or more images patches. In the example of FIG. 2, the image encoder neural network generates an image embedding for each of a total of three images patches, which correspond respectively to regions 214A-C in the image 202.

In these implementations, the one or more images patches can be generated from the image 202 by the neural network system 200 by using a region proposal neural network 210 which is included in or accessible by the system. The region proposal neural network 210 can be a neural network that is configured to process a region proposal network input that includes (i) the image 202 and (ii) prompt text (referred to below as “region proposal prompt text”) 212 in accordance with the parameters of the region proposal neural network to generate, conditioned on the region proposal prompt text 212, a region proposal network output that includes one or more image patches. Each image patch corresponds to a respective region, e.g., region 214A, region 214B, or region 214C, in the image 202.

To that end, the region proposal neural network 210 can be a multi-modal neural network that has been trained on an object detection task, a semantic segmentation task, or another computer vision task. As a particular example, the region proposal neural network 210 can be a multi-modal Transformer neural network described in Maaz, Muhammad, et al. “Multi-modal transformers excel at class-agnostic object detection.” arXiv preprint arXiv: 2111.11430, 2021.

The region proposal prompt text 212 can be a predetermined text sequence defined by a system administrator that generally describes the target content that should be identified from the image 202. Thus, when the neural network system 200 provides a text sequence that is related to, includes, or is otherwise associated with the multiple keywords from the dataset 230 as the region proposal prompt text 212, the region proposal neural network 210 is capable of identifying one or more regions in the image 202 that are each determined by the neural network as likely containing content related to one or more of the multiple keywords.

The neural network system 200 also includes or has access to an optical character recognition (OCR) engine 220 that implements a text recognition algorithm, e.g., a scene text recognition algorithm, to recognize texts depicted in images. The system provides the image 202 as input to the OCR engine 220 to obtain OCR text in the image 202.

The neural network system 200 then uses (i) the image embedding that has been generated by using the image encoder neural network, (ii) the image embedding for each of the one or more images patches that has likewise been generated by using the image encoder neural network, (iii) the one or more text embeddings that has been generated by using the text encoder neural network, and (iv) the OCR text that has been obtained by using the OCR engine to select (i) a keyword that is most relevant to the content depicted in the image and (ii) supplemental information corresponding to the selected keyword.

In particular, the neural network system 200 makes this selection based on the match results of the keywords with respect to the OCR text and on the similarity measures between the image and text embeddings in accordance with a set of ensemble rules 250, as will be described further below with reference to FIG. 6.

Instead of or in addition to using the selected keyword and supplemental information 231 to assist the VLM neural network 205 in performing a multi-modal machine learning task on an input to generate an output as mentioned above, the neural network system 200 can take a number of different actions based on the selected keyword and supplemental information 231.

In some implementations, the neural network system 200 determines, based on the selected keyword and the supplemental information 231, whether to provide the image 202 for presentation on a client device 280, e.g., the client device that submits the image 202. In some of these implementations, the image 202 is provided as-is to the client device 280 while in others of these implementations, the image 202 is provided as part of another digital component to the client device 280. That is, the neural network system 200 can generate a digital component that includes the image as a portion of the content, e.g., in addition to other text, audio, or video content, shown in the digital component, and then provide the digital component that includes image 202 for presentation on the client device.

A client device 280 is an electronic device capable of requesting and receiving online resources over a network 282. Example client devices 280 include personal computers, gaming devices, mobile communication devices, digital assistant devices, augmented reality devices, virtual reality devices, and other devices that can send and receive data over the network 282. A client device 280 typically includes a user application, such as a web browser, to facilitate the sending and receiving of data over the network, but native applications (other than browsers) executed by the client device 280 can also facilitate the sending and receiving of data over the network 282.

As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

In some implementations, the neural network system 200 generates a digital component that include the selected keyword, the supplemental information corresponding to the selected keyword, or both, and similarly provides the digital component for presentation on a client device.

In some implementations, the neural network system 200 determines, based on the selected keyword and the supplemental information corresponding to the selected keyword, whether and, if so, how to modify the image 202, e.g., prior to providing the modified image for presentation on a client device. Depending on the selected keyword and supplemental information 231, the system can for example apply one or more operations comprising zooming-in or zooming-out of a target object depicted in the image 202, blurring of a portion of the image 202, overlaying animations on the image 202, and so on.

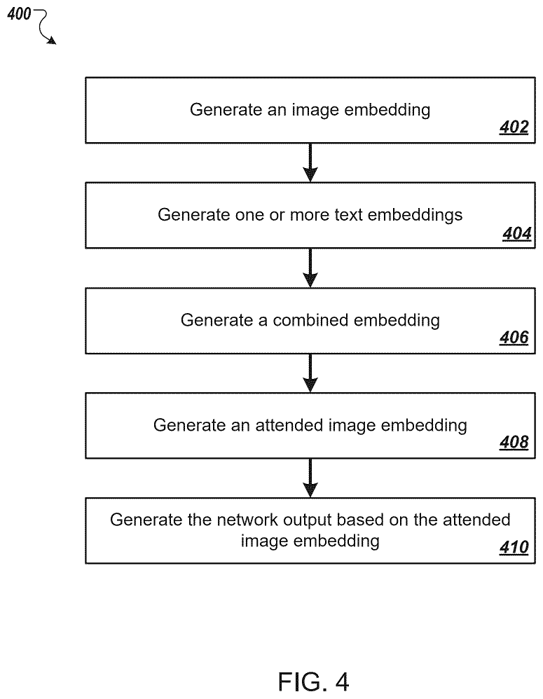

FIG. 4 is a flow diagram of an example process 400 for performing a multi-modal machine learning task on a network input to generate a network output. For convenience, the process 400 will be described as being performed by a system of one or more computers located in one or more locations. For example, a neural network system, e.g., the neural network system 100 of FIG. 1, appropriately programmed, can perform the process 400.

The system includes a vision-language model (VLM) neural network that is configured to perform the multi-modal machine learning task on the network input, which includes text and an image, to generate the network output. The VLM neural network includes a VLM backbone neural network and an attention-based feature adapter. The VLM backbone neural network includes an image encoder neural network and a text encoder neural network.

The system process, using the image encoder neural network of the VLM backbone neural network, the image included in the network input to generate an image embedding (step 402).

The system process, using the text encoder neural network of the VLM backbone neural network, text included in the network input to generate one or more text embeddings (step 404). In some cases, the text includes multiple text segments, e.g., that are separated by predetermined separator tokens included within the text. Each text segment defines a different candidate network output for the task. In these cases, the system uses the text encoder neural network to generate a corresponding text embedding for each text segment that defines a candidate network output. Moreover, in some cases where the VLM neural network selects from an external database one or more text items relevant to the task, the system also uses the text encoder neural network to generate a corresponding text embedding for each selected text item.

The system combines the image embedding, the one or more text embeddings, and respective positional embeddings to generate a combined embedding (step 406). The system can generate the combined embedding by concatenating the one or more text embeddings, e.g., the text embeddings generated from the text included in the network input and, optionally, the selected text items, one after another to the image embedding in a given order and along a given (e.g., horizontal) dimension. The system can then combine, e.g., sum or average, the concatenated embedding with a positional embedding for each embedding in the given order.

In this way, each embedding in the concatenated embedding is combined with an embedding that is indicative of the embedding's position in the concatenated embedding. For example, the positional embedding for the image embedding will be different from the positional embeddings for the text embeddings that follow the image embedding in the concatenated embedding. The use of positional embeddings can enable the system to distinguish between the embeddings generated from different data modalities.

In some cases, the positional embeddings are learned. As used in this specification, the term “learned” means that an operation or a value has been adjusted during the training of the VLM neural network. In some other cases, the positional embeddings are fixed and are different for each embedding position. For example, the embeddings can be made up of sine and cosine functions of different frequencies.

The system processes, using the attention-based feature adapter of the VLM backbone neural network, the combined embedding to generate an attended combined embedding (step 408). The attention-based feature adapter includes an attention layer that is configured to update the combined embedding based on applying an attention mechanism.

Generally, to apply the attention mechanism, the attention layer uses one or more attention heads. Each attention head generates a set of queries, a set of keys, and a set of values, e.g., by applying a query (or, analogously, a key or a value) linear transformation to the combined embedding, and then applies any of a variety of variants of query-key-value (QKV) attention using the queries, keys, and values to generate an output. Each query, key, or value can be a vector. When there are multiple attention heads, the attention layer then combines the outputs of the multiple attention heads, e.g., by concatenating the outputs and, optionally, processing the concatenated outputs through a linear layer.

After applying the attention mechanism, the system generates an attended image embedding from the attended combined embedding. Because the attended combined embedding has the same dimensionality as the combined embedding, the system can obtain the attended image embedding by selecting a segment of the attended combined embedding (e.g., selecting a proper subset of all numeric values included in the attended combined embedding) based on the order in which the image embedding and the one or more text embeddings are combined.

In some cases, the attended image embedding is the final output of the attention layer. In other cases, the attention-based feature adapter applies one or more other operations, e.g., residual connections, layer normalization, or both, to the attended combined embedding to generate the final output. For example, the system can generate a combination of the attended image embedding with the image embedding, then apply layer normalization to the combination, and then provide the normalized combination as the final output.

The system generates, using the attention-based feature adapter of the VLM backbone neural network, the network output based on the attended image embedding (step 410). The attention-based feature adapter includes a final layer that is configured to receive the attended image embedding and process the attended image embedding to generate the network output as required by the multi-modal machine learning task.

For example, the attention-based feature adapter can include a softmax layer as the final layer. The softmax layer receives and processes the final output of the attention layer to output a respective numerical probability value for each candidate network output defined by the text included in the network input. To generate the network output from the probability output of the final layer, the system can select a candidate network output, e.g., by sampling a network output in accordance with the probability values for the network outputs, or by selecting the network output with the highest probability value.

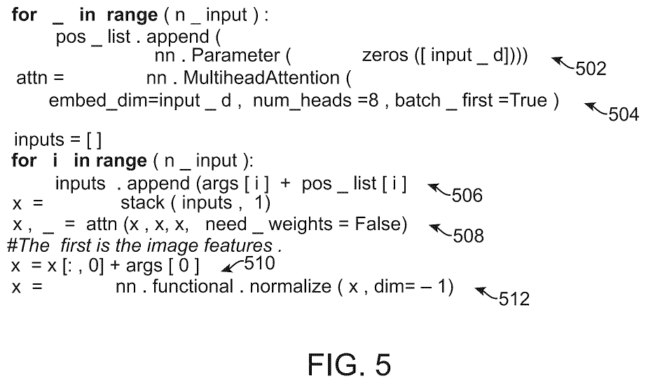

FIG. 5 shows example pseudo code to implement an attention-based feature adapter. At reference 502, positional embeddings are defined (as learned positional embeddings and rather than fixed). At reference 504, the attention mechanism is defined (as a multi-head attention mechanism that uses a total of 8 attention heads). At reference 506, a combined embedding is generated by appending the text embeddings to the image embedding, and adding the predefined positional embeddings. At reference 508, the predefined attention mechanism is applied on the combined embedding to generate an attended combined embedding. At reference 510, an attended image embedding is obtained from the attended combined embedding (based on the original position of the image embedding within the combined embedding). The attended image embedding is then combined with the image embedding. At reference 512, layer normalization is applied to this combination.

FIG. 6 is a flow diagram of an example process 600 for selecting a keyword and supplemental information corresponding to the keyword from a database. For convenience, the process 600 will be described as being performed by a system of one or more computers located in one or more locations. For example, a neural network system, e.g., the neural network system 100 of FIG. 1, appropriately programmed, can perform the process 600.

The system includes a vision-language model (VLM) neural network that is configured to perform the multi-modal machine learning task on the network input to generate the network output. The VLM neural network includes a VLM backbone neural network and an attention-based feature adapter. The VLM backbone neural network includes an image encoder neural network and a text encoder neural network.

The system maintains a database that stores multiple keywords and, for each keyword, supplemental information corresponding to the keyword (step 602). The keywords and the supplemental information are typically maintained in the form of text items.

The system receives an image (step 604). The system can receive the image in any of a variety of ways. For example, the system can receive the image as an upload from a client device of the system over a data communication network, e.g., using an application programming interface (API) made available by the system. As another example, the system can receive an input from the client device specifying which image that is already maintained by the system or another system that is accessible by the system should be used as the image.

The system processes a region proposal network input that includes (i) the image and (ii) region proposal prompt text using a region proposal neural network to identify one or more regions in the image that are determined to likely contain content related to one or more of the multiple keywords stored in the database (step 606). The region proposal prompt text can be a predetermined text sequence, such as one defined by a system administrator, that generally describes the target content that should be identified from the image. For example, the region proposal prompt text can be “all objects,” “all logos,” “all icons,” or the like.

The system processes one or more image encoder network inputs that include one or more images patches using an image encoder neural network to generate an image embedding for each of the one or more images patches (step 608). Each image patch corresponds to one of the regions within the image that have been identified by the region proposal neural network given the region proposal prompt text.

In some implementations, the system also processes an image encoder network input that includes the entire image using the image encoder neural network to generate an image embedding for the entire image.

In some implementations, the system also processes the image using an optical character recognition (OCR) engine to obtain OCR text corresponding to any text depicted in the image.

For each of the multiple keywords stored in the database, the system processes one or more text encoder network inputs that each include at least the keyword using a text encoder neural network to generate one or more text embeddings for the keyword (step 610). For example, for each keyword, the text encoder network inputs can each include (i) the keyword and, (ii) the supplemental information corresponding to the keyword, (iii) text encoder prompt text, or both (ii) and (iii). The text encoder network inputs for the same keyword can include different text encoder prompt text than each other.

While in some implementations the system can repeatedly perform step 610 to generate the text embeddings for the multiple keywords stored in the database at each iteration of process 600, in other implementations, the system can store the text embeddings generated during the first iteration of process 600 in a data repository and correspondingly, reuse the stored text embeddings at later iterations of process 600, such that the process 600 jumps from step 608 to step 612, skipping step 610.

The system determines similarity measures between (i) the image embedding for each of the one or more images patches and, optionally, for the entire image (ii) the one or more text embeddings for each of the multiple keywords (step 612). In particular, in some implementations, the similarity measure is a pairwise similarity measure. That is, for each image embedding, the system determines a similarity measure between the image embedding and each of the one or more text embeddings that have been generated for each of the multiple keywords stored in the database. Here, the “similarity measure” is defined in terms of a distance in the embedding space. The distance may be computed in any appropriate way, such as with Euclidean distance, Hamming distance, cosine similarity, to name just a few examples.

In implementations where OCR text is obtained from the image, the system also determines a match result of each of the multiple keywords stored in the database with respect to the OCR text. The match results will indicate whether any keyword from among the multiple keywords is included as a portion of the OCR text and, if so, which keyword is included in the OCR text. Additionally or instead, the match results will indicate a percentage match, e.g., in the case where the OCR text includes multiple words, each of which are being compared with the keywords. The multiple keywords are either compared with the OCR text in a case-sensitive manner or in a case-insensitive manner. In some implementations, a keyword is considered as being included as a portion of the OCR text, e.g., considered a match with the OCR text, if it is a phrase of the OCR text, e.g., a keyword “abc” is considered as being included in OCR text “abc def” but not in “abcdef”.

The system selects, based at least on the similarity measures, from the database (i) a keyword that is most relevant to the content depicted in the image and (ii) supplemental information corresponding to the selected keyword (step 614). For example, the system can identify the highest similarity measure from among all similarity measures that have been determined between the image embeddings and the text embeddings, and correspondingly select, as the keyword that is most relevant to the content depicted in the image, a keyword based on which a text embedding associated with this identified similarity measure is generated. Other ways to select the keyword are possible, for example, by using only a subset of all of the similarity measures.

In implementations where OCR text match results are determined, the system can make this selection based on not only the similarity measures but also the match results. For example, the system can do so in accordance with a set of ensemble rules, which assign different weights to the match results and the similarity measures. Here, the “weight” is the weight for consideration when selecting keywords from the database.

For example, one ensemble rule can assign a greater weight to match results than similarity measures, such that when the keyword matched with the OCR text is different from the keyword selected using the similarity measures, the system will select the keyword matched with the OCR text as the keyword that is most relevant to the content depicted in the image. As another example, when multiple keywords are matched with the OCR text, one ensemble rule can assign an infinitely small weight to each of the multiple keywords, such that the system will primarily use the similarity measures to select the keyword.

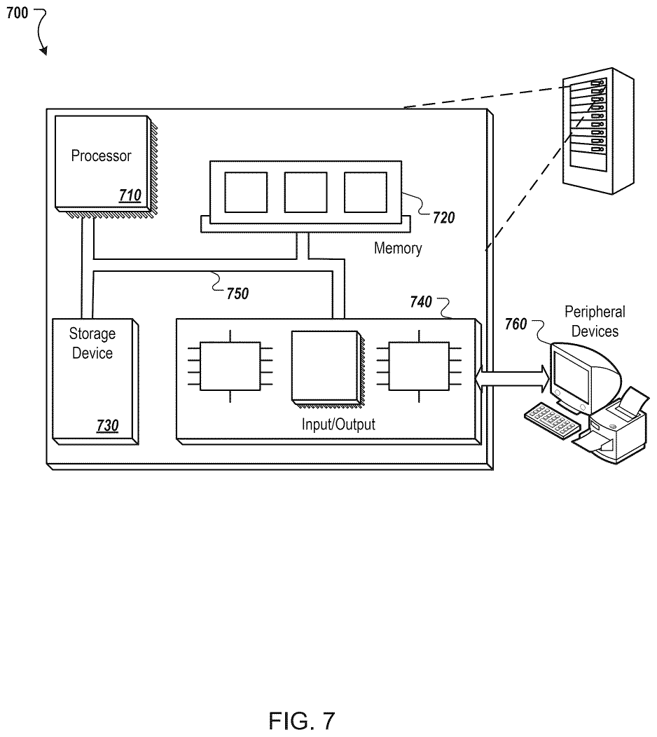

FIG. 7 is block diagram of an example computer system 700 that can be used to perform operations described above. The system 700 includes a processor 710, a memory 720, a storage device 730, and an input/output device 740. Each of the components 710, 720, 730, and 740 can be interconnected, for example, using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 can include, for example, a hard disk device, an optical disk device, a storage device that is shared over a network by multiple computing devices (e.g., a cloud storage device), or some other large capacity storage device.

The input/output device 740 provides input/output operations for the system 700. In one implementation, the input/output device 740 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 370. Other implementations, however, can also be used, such as mobile computing devices, mobile communication devices, set-top box television client devices, etc.

Although an example processing system has been described in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A system for performing a multi-modal machine learning task on a network input that comprises text and an image to generate a network output, the system comprising one or more computers and one or more storage devices storing instructions that, when executed by the one or more computers, cause the one or more computers to implement:
a vision-language model (VLM) neural network configured to perform the multi-modal machine learning task, the VLM neural network comprising:
a backbone image encoder neural network configured to process the image included in the network input to generate an image embedding;
a backbone text encoder neural network configured to process the text included in the network input to generate one or more text embeddings; and
an attention-based feature adapter, the attention-based feature adapter configured to:
combine the image embedding, the one or more text embeddings, and respective positional embeddings to generate a combined embedding;
generate an attended image embedding at least in part by applying an attention mechanism to the combined embedding; and
generate the network output based on the attended image embedding.

2. The system of claim 1, wherein the backbone image encoder neural network and the backbone text encoder neural network are jointly pre-trained on a text-image alignment task, the backbone image encoder neural network and the backbone text encoder neural network each having a respective plurality of pre-trained parameter values determined from the pre-training.

3. The system of claim 1, wherein generating the attended combined image embedding comprises:
generating an attended combined embedding at least in part by applying the attention mechanism by using queries, keys, and values derived from the combined embedding; and
generating, in accordance with an order in which the image embedding and the one or more text embeddings are combined, the attended image embedding from the attended combined embedding.

4. The system of claim 1, wherein generating the network output based on the attended image embedding comprises:
generating a combination of the attended image embedding with the image embedding; and
generating the network output from the combination.

5. The system of claim 1, wherein the attention mechanism comprises a multi-head attention mechanism.

6. The system of claim 1, wherein the multi-modal machine learning task comprises an agent control task, and the network output specifies one or more actions to be performed by the agent.

7. The system of claim 6, wherein the agent comprises a robot.

8. The system of claim 1, wherein the multi-modal machine learning task comprises one of an image captioning task or a visual question answering task.

9. (canceled)

10. (canceled)

11. A computer-implemented method comprising:
maintaining a database that stores a plurality of keywords and, for each keyword, supplemental information corresponding to the keyword;
receiving an image;
processing a region proposal network input that comprises the image using a region proposal neural network to identify one or more regions in the image that are determined to likely contain content related to one or more of the plurality of keywords;
processing one or more image encoder network inputs that comprise one or more images patches corresponding to the one or more regions using an image encoder neural network to generate an image embedding for each of the one or more images patches;
for each of the plurality of keywords, processing one or more text encoder network inputs that each comprise at least the keyword using a text encoder neural network to generate one or more text embeddings for the keyword;
determining similarity measures between (i) the image embedding for each of the one or more images patches and (ii) the one or more text embeddings for each of the plurality of keywords; and
selecting, based at least on the similarity measures and from the database, (i) a keyword that is most relevant to the content depicted in the image and (ii) supplemental information corresponding to the selected keyword.

12. The method of claim 11, further comprising:
processing the image using optical character recognition (OCR) to obtain OCR text corresponding to text depicted in the image.

13. The method of claim 12, wherein selecting the selected keyword that is most relevant to the content depicted in the image further comprises:
determining a match result of each of the plurality of keywords with respect to the OCR text; and
selecting the keyword based on both the similarity measures and the match results.

14. The method of claim 13, wherein selecting the keyword based on both the similarity measures and the match results comprises:
selecting the keyword in accordance with a set of ensemble rules that are configured to assign different weights to the match results and the similarity measures.

15. The method of claim 11, wherein the region proposal neural network comprises a multi-modal Transformer neural network that has been pre-trained on an object detection task.

16. The method of claim 15, wherein the region proposal network input further comprises region proposal prompt text.

17. The method of claim 11, wherein generating the image embedding for each of the one or more regions further comprises:
processing an image encoder network input that comprises the image using the image encoder neural network to generate an image embedding for the image.

18. The method of claim 11, wherein the text encoder network input comprises (i) the keyword and, (ii) the supplemental information corresponding to the keyword, (iii) text encoder prompt text, or both (ii) and (iii).

19. The method of claim 11, further comprising:
determining, based on the selected keyword and the supplemental information corresponding to the selected keyword, whether to provide the image for presentation on a client device.

20. The method of claim 19, wherein providing the image for presentation on the client device comprises:
generating a digital component that includes the image; and
providing the digital component that includes image for presentation on the client device.

21. The method of claim 11, further comprising:
determining, based on the selected keyword and the supplemental information corresponding to the selected keyword, whether to modify the image.

22. The method of claim 11, further comprising:
generating a digital component that include the selected keyword, the supplemental information corresponding to the selected keyword, or both.

23. (canceled)

24. (canceled)
